(19) United States
(12) Patent Application Publication
(10) Pub. No.: US 2001/0039998 A1
(43) Pub. Date: Nov. 15, 2001

(54) PROCESS FOR THE PRODUCTION OF LAMINATED POCKETS AND LAMINATED POCKET

(76) Inventor: HARALD SENGES, OBERSTEINENBERG (DE)

Correspondence Address: QUARLES & BRADY LLP, 411 E. WISCONSIN AVENUE, SUITE 2040, MILWAUKEE, WI, 53202-4497, US

(21) Appl. No.: 09/168,784

(22) Filed: Oct. 8, 1998

(30) Foreign Application Priority Data
Oct. 9, 1997 (DE) 197 44 595.0

(51) Int. Cl. B31F 1/00; B32B 31/00

(52) U.S. Cl. 156/227; 156/264

(57) ABSTRACT

A laminated pocket or card, in which is to be legibly housed a sheet of paper or a photograph, is produced in that on in each case one side of two identically large pieces of polypropylene or polyethylene film, is applied a thin adhesive coating.

The sheet of paper is inserted between the film pieces, the adhesive-coated sides of the films facing the paper sheet. In this state the three layers are laminated.

### DESCRIPTION

Laminated pockets or cases are used for completely enclosing in a plastic film a piece of paper, e.g. an identity card. As a rule, the laminated pockets are formed from two pieces of film interconnected along a front edge. The connection can be a subsequent joint between two pieces of film or also a fold of a larger piece of film. The paper sheet is then inserted in such laminated pockets. A laminating apparatus is then used to perform the actual lamination process.

In the known laminated pockets or cases use is made of a film, which comprises two layers. To one side is then applied the adhesive, so that the two film portions which together form the laminated pocket, in each case comprise three layers.

The problem of the invention is to propose a process for producing laminated pockets or cases, which allows better results.

A further problem of the invention is to provide an improved laminated pocket or case.

For solving the set problem, the invention proposes a process having the features of claim 1. The invention also proposes a laminated pocket, which can be produced by the process according to claim 1. Further developments of the invention form the subject matter of subclaims, whose wording, like that of the abstract, is by reference formed into part of the content of the present description.

The invention makes use of a starting material in the form of a single layer of film, to which is applied a coating of adhesive. Two adhesive-coated film portions then form a laminated pocket, in which a sheet of paper can be inserted and laminated. Lamination takes place, accompanied by a simultaneous application of pressure and heat.

According to a further development of the invention, the adhesive is non-uniformly applied to at least one of the two film portions, particularly in the form of small heaps or linearly. The adhesive is then uniformly distributed, without air bubbles forming.

According to the invention, the film material can in particular be polypropylene, which is particularly environmentally friendly. It is also possible to use polyethylene as the film material.

According to the invention, use can be made of films with a modulus of elasticity between approximately 100 and 2000 N/mm².

The adhesive can be constituted by a thermoplastic adhesive, as well as a water-soluble adhesive or a dispersion-based adhesive.

The viscosity of the adhesive is preferably between approximately 100 and approximately 2000 mPas.

According to a further development of the invention, the adhesive can in particular be applied by a knife coating process.

It is also possible to spray on the adhesive or apply it with a roller. Combinations of these three possibilities for the application of the adhesive to the film are also possible.

In particular, according to the invention, between 5 and 40 of adhesive are applied per m².

Further features, details and advantages of the invention can be gathered from the following description of a preferred embodiment and the attached drawings, wherein show:

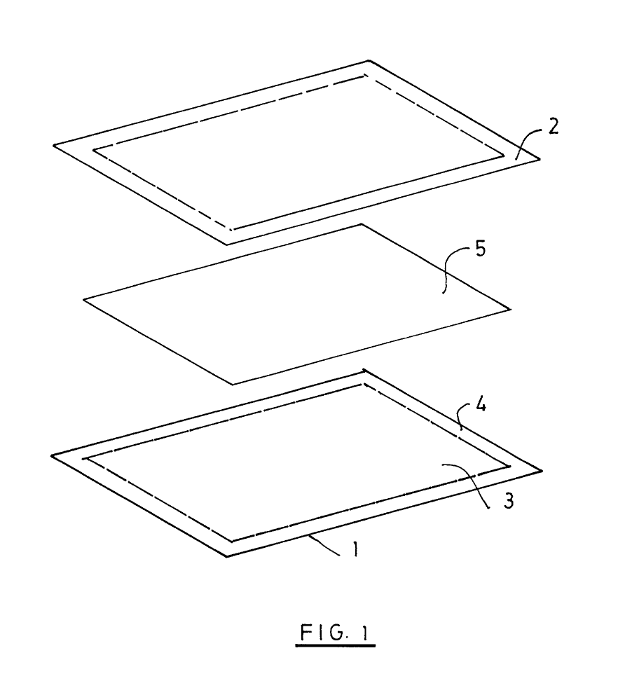

FIG. 1 Diagrammatically the arrangement of a paper sheet to be laminated in between two pieces of film of the same size.

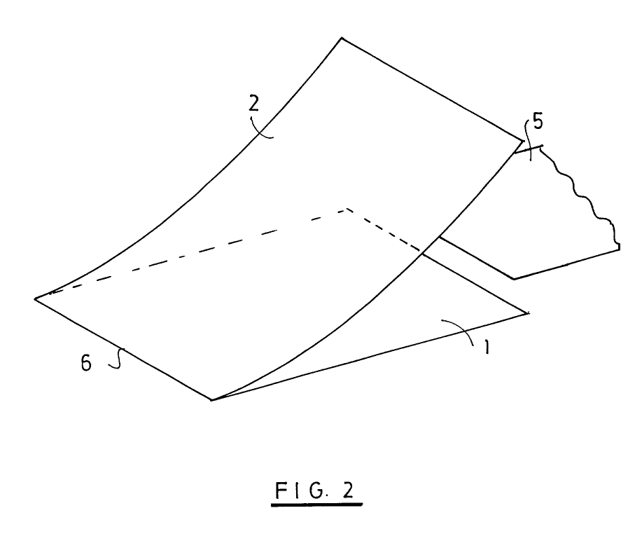

FIG. 2 A laminated pocket, in which the two film portions are joined together along a front edge.

FIG. 1 shows two pieces of film 1, 2, which are of the same size and thickness and are preferably made from the same material, particularly polypropylene or polyethylene. On one side and up to the border, each piece of film is provided with a thin adhesive coating 3. The adhesive coating can be applied with a doctor knife, a roller, a brush, etc., but can also be sprayed on. The pieces of film 1, 2 are so arranged that the adhesive-coated sides face one another. In the drawing, in the case of the lower piece of film it is the top side and in the case of the upper piece of film the bottom side. Between the two pieces of film is placed a sheet of paper 5, which is positioned in the manner indicated by the broken line, being surrounded throughout by a border. The three oriented parts are placed on one another and laminated. As a result the sheet 5 is so fixed between the films that a manipulation is impossible.

During lamination, the arrangement of the two film portions with the interposed pieces of paper is heated and pressed, so that the adhesive is activated and there is a bonding between the film and paper on the one hand and between the two films, along the border on the other. The border 4 is chosen in such a way that all around the sheet 5 a tight connection between the films is obtained.

The sheet can also be a photograph, which is then enclosed in non-destructive manner.

The adhesive can be applied e.g. as small heaps, the size and spacing for a heap being one or two millimeters in approximate manner.

The arrangement shown in FIG. 1 is particularly suitable if the laminated pocket is used in a company. It can be assumed that the participating persons know the order in which the film pieces are to be arranged.

However, as the laminated pockets or cases are also suitable for domestic use or for use by untrained persons, a second embodiment is proposed, which is diagrammatically represented in FIG. 2. For reasons of simplicity, the same reference numerals as in FIG. 1 are used. Unlike in the embodiment of FIG. 1, the two film portions 1, 2 are already interconnected along a front edge 6.

The sheet 5 to be introduced, e.g. a photograph, consequently need only be inserted from the side, remote from the joined front edge 6 between the two pieces of film. The lamination can then take place in the same way as for the embodiment according to FIG. 1. A laminated pocket, in which the two portions of film are already joined together, has the advantage that it can be more easily used by the final consumer.

Joining can not only be brought about by holding, but also by welding or bonding.

1. Process for the production of a laminated pocket, wherein
1.1 a hot-melt adhesive is heated and
1.2 applied to one side of a film,
1.3 the adhesive is cooled,
1.4 the film is cut to the correct size for the laminated pocket to be produced and
1.5 two identically large portions of the film with their adhesive-coated sides facing one another are arranged in congruent manner.

2. Process according to claim 1, wherein the two film portions (1, 2) are welded together along an edge (6).

3. Process according to claim 1, wherein the two film portions (1, 2) are laminated together along an edge (6).

4. Process according to claim 1 or 3, wherein the two film portions (1, 2) are formed by folding a twice as large piece of film.

5. Process according to one of the preceding claims,-wherein the film comprises a single layer.

6. Process according to one of the preceding claims, wherein the adhesive is applied in non-uniform manner, particularly in small heaps or linearly.

7. Process according to one of the preceding claims, wherein the adhesive is dusted on.

8. Process according to one of the preceding claims, wherein polypropylene is used as the film.

9. Process according to one of the preceding claims, wherein polyethylene is used as the film.

10. Process according to one of the preceding claims, wherein use is made of films with a modulus of elasticity of 100 to 2000 N/mm².

11. Process according to one of the preceding claims, wherein the film is adjusted in such a way that it is impermeable to UV-light.

12. Process according to one of the preceding claims, wherein a water-soluble adhesive is used.

13. Process according to one of the preceding claims, wherein a dispersion-based adhesive is used.

14. Process according to one of the preceding claims, wherein use is made of an adhesive with a viscosity of 100 to 2000 mPas.

15. Process according to one of the preceding claims, wherein the adhesive is applied by a knife coating process.

16. Process according to one of the preceding claims, wherein the adhesive is sprayed on.

17. Process according to one of the preceding claims, wherein the adhesive is applied with a roller.

18. Process according to one of the preceding claims, wherein between 5 and 40 g of adhesive are applied per m².

19. Laminated pocket, manufacturable by the process according to one of the preceding claims.

20. Laminated pocket according to claim 19 comprising two identically large, congruently arranged pieces of film, whose facing sides are coated with a hot-melt adhesive.

21. Laminated pocket according to claim 19 or 20, wherein the two film portions (1, 2) are welded together along the lateral edge (6).

22. Laminated pocket according to claim 19 or 20, wherein the two film portions (1, 2) are produced by folding a twice as large piece of film.
